(19) United States
(12) Patent Application Publication
(10) Pub. No.: US 2018/0017259 A1
(43) Pub. Date: Jan. 18, 2018

(54) Transition Duct Exit Holder and Inlet Ring Support Arrangement

(71) Applicant: Siemens Energy, Inc., Orlando, FL (US)

(72) Inventor: Anthony L. Schiavo, Oviedo, FL (US)

(21) Appl. No.: 15/208,265

(22) Filed: Jul. 12, 2016

(51) Int. Cl. F23R 3/60; F01D 9/02; F02C 7/28

(52) U.S. Cl. CPC F23R 3/60; F02C 7/28; F01D 9/023; F05D 2220/32; F05D 2300/10; F05D 2300/6033; F05D 2240/35

(57) ABSTRACT

A gas turbine engine has a transition duct supporter that is able to support and accommodate the operation of the gas turbine engine. The transition duct supporter is located between a metallic integrated exit piece and a transition duct that is made of ceramic matrix composites.

### STATEMENT REGARDING FEDERALLY SPONSORED DEVELOPMENT

This invention was made with government support under Program DE-FE0023955, awarded by the United States Department of Energy. The government has certain rights in the invention.

### BACKGROUND

### 1. Field

Disclosed embodiments are generally related to gas turbine engines and, more particularly to the transition system used in gas turbine engines.

### 2. Description of the Related Art

A gas turbine engine typically has a compressor section, a combustion section having a number of combustors and a turbine section. Ambient air is compressed in the compressor section and conveyed to the combustors in the combustion section. The combustors combine the compressed air with a fuel and ignite the mixture creating combustion products. The combustion products flow in a turbulent manner and at a high velocity. The combustion products are routed to the turbine section via transition ducts. Within the turbine section are rows of vane assemblies. Rotating blade assemblies are coupled to a turbine rotor. As the combustion product expands through the turbine section, the combustion product causes the blade assemblies and turbine rotor to rotate. The turbine rotor may be linked to an electric generator and used to generate electricity.

During the operation of gas turbine engines strong forces are generated that can impact the structure of the gas turbine engine. These forces may occur in the transition duct. Accommodating these forces to avoid breakage is important for the continued operation of the gas turbine engine.

### SUMMARY

Briefly described, aspects of the present disclosure relate to the transition system of a gas turbine engine.

An aspect of the disclosure may be a gas turbine engine comprising a combustor basket; a transition duct connected to the combustor basket, wherein the transition duct has a crown portion forming a first curved surface and an inlet extension piece connected to the transition duct with a transition duct supporter. The transition duct support comprises a crown holder, wherein the crown holder has a first holder portion having a second curved surface and a second holder portion having a third curved surface, wherein the second curved surface and third curved surface interfaces with the first curved surface; and a seal portion secured to the crown holder, wherein the seal portion abuts the inlet extension piece thereby inhibiting the flow of air.

Another aspect of the present disclosure may be a gas turbine engine comprising; a combustor basket; a transition duct connected to the combustor basket, wherein the transition duct has a crown portion forming a first curved surface; and an inlet extension piece connected to the transition duct with a transition duct supporter. The transition duct supporter comprises; a crown lock, wherein the crown lock has a second curved surface that interfaces with the first curved surface; a seal portion abutting the inlet extension piece thereby inhibiting the flow of air; and a spacer separating the crown lock from the seal portion, wherein the seal portion and the crown lock are secured together through the spacer.

Still another aspect of the present disclosure may be a transition duct supporter for use in gas turbine engines having a crown holder, wherein the crown holder has a first holder portion having a first curved surface and a second holder portion having a second curved surface, wherein the first curved surface and second curved surface interfaces with a third curved surface of a crown portion formed on a transition duct; and a seal portion secured to the crown holder, wherein the seal portion abuts an inlet extension piece thereby inhibiting the flow of air.

### BRIEF DESCRIPTION OF THE DRAWINGS

FIG. 1 shows a view of the transition system in a gas turbine engine.

FIG. 2 is a cross-sectional view of the transition system in a gas turbine engine.

FIG. 3 is a close up view of a transition duct supporter.

FIG. 4 is another close up view of the transition duct supporter.

FIG. 5 shows a view of the air supply holes.

FIG. 6 shows a view of the purging holes.

FIG. 7 is another view of the transition duct supporter located between an inlet extension piece and transition duct.

FIG. 8 is a view of the installation of the first holder portion and second holder portion on the transition duct.

FIG. 9 is a view of the transition duct supporter installed on the transition duct.

FIG. 10 is shows an alternative embodiment of a transition duct supporter.

FIG. 11 is a cross-sectional view of the alternative embodiment of the transition duct supporter.

FIG. 12 shows the alternative embodiment placed on the transition duct.

FIG. 13 shows a cross-sectional view of an alternative embodiment of the transition duct supporter shown in FIGS. 10-12.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

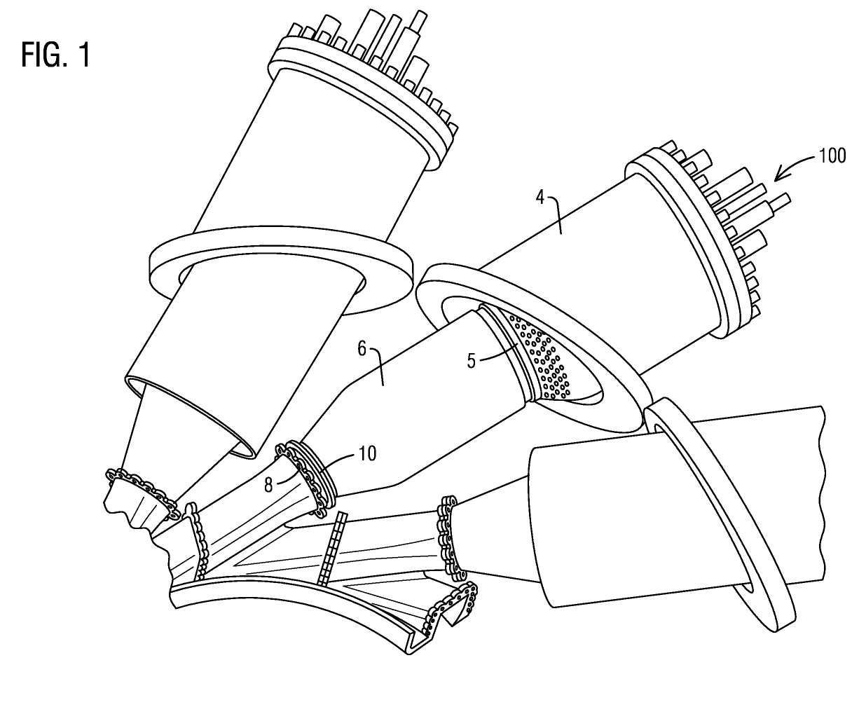

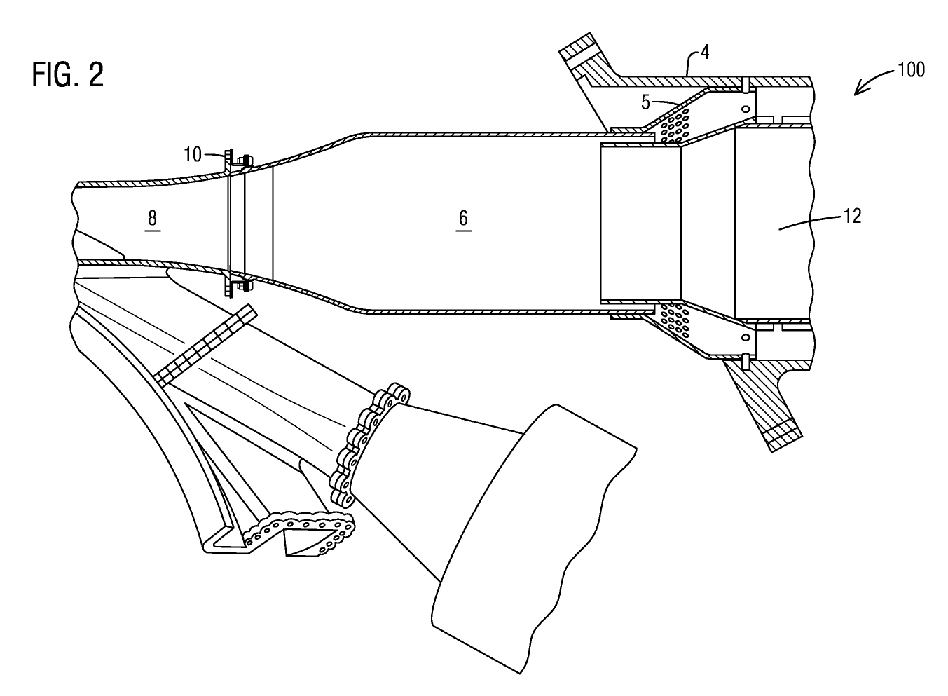

FIGS. 1 and 2 show a view of the transition system in a gas turbine engine 100. Shown are the spool piece 4 and the structural support cone 5 which surrounds and structurally protects the combustor basket 12. Also shown is the transition duct 6 connected to the combustor basket 12 at the upstream end of the transition duct 6 and the integrated exit piece (IEP) 8 at the downstream end of the transition duct 6. Working gases flow downstream from the combustor basket 12 through the transition duct 6 and then through the IEP 8. In the embodiment shown the IEP 8 is made of metallic material while the transition duct 6 is made of ceramic matrix composites (CMC). The use of CMC material for the transition duct 6 while having a metallic IEP 8 encourages use of the transition duct supporter 10 in order to accommodate the different responses the materials have to thermal changes that occur during operation of the gas turbine engine 100.

Transition duct supporter 10 is located between the transition duct 6 and the IEP 8. The transition duct supporter 10 helps maintain the orientation of the transition duct 6 with respect to the IEP 8 and combustor basket 12 during operation of the gas turbine engine 100. The transition duct supporter 10 allows small amounts of swivelling of the transition duct 6 during installation of the transition duct 6 to the IEP 8 and during operation of the gas turbine engine 100. The transition duct supporter 10 further seals the gap that exists between the IEP 8 and the transition duct 6. The transition duct supporter 10 also supports the transition duct 6 during gas flow thrust load while allowing yielding during thermal deformations and displacements.

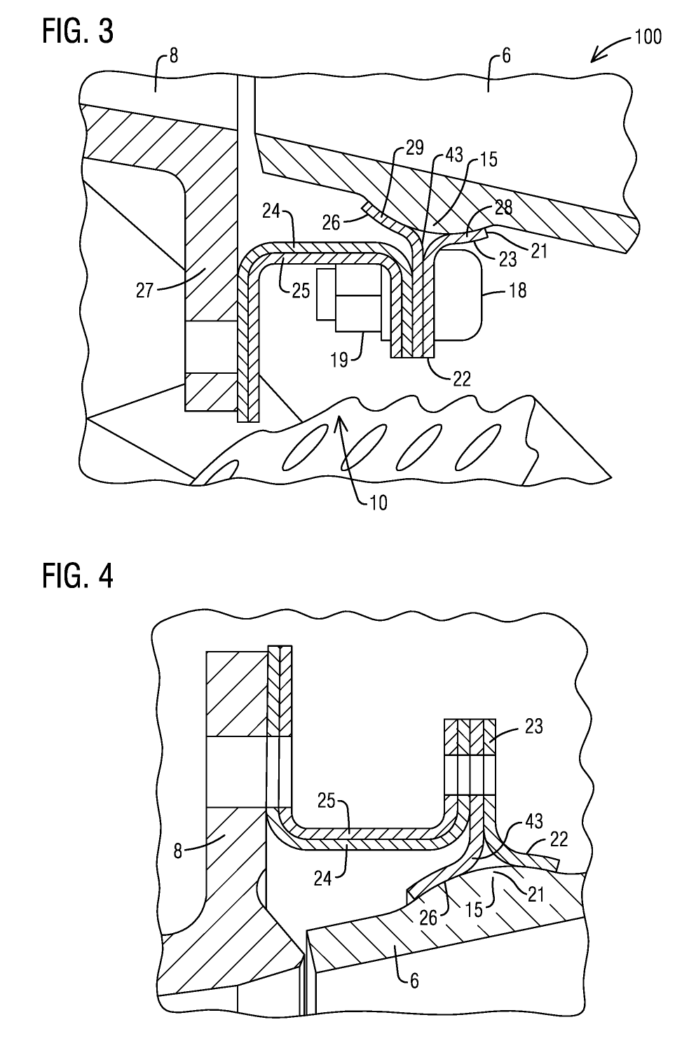

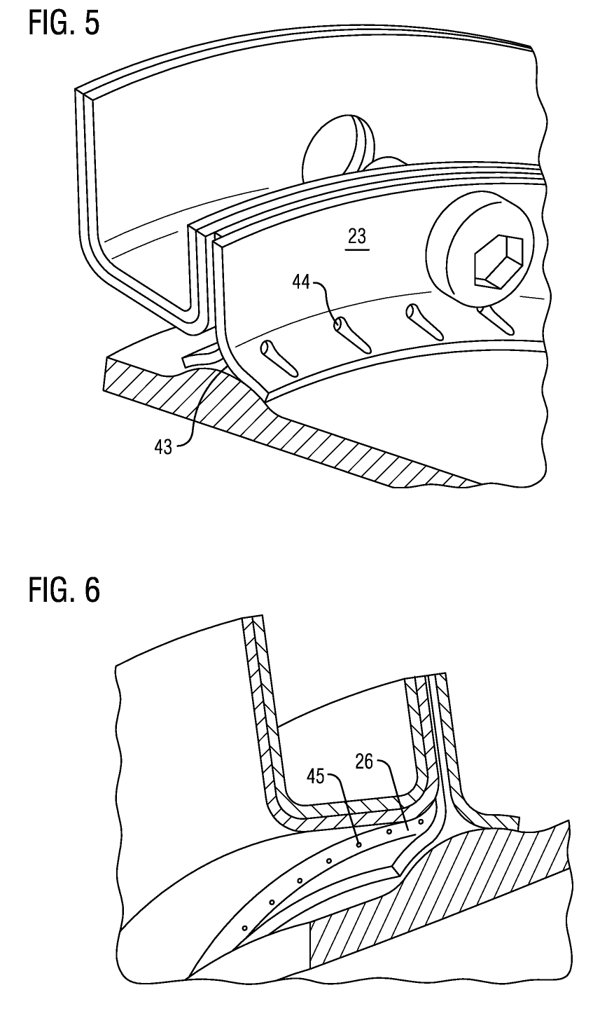

FIGS. 3-7 show close up cross-sectional views of the transition duct supporter 10. The transition duct supporter 10 has a crown holder 22 and a seal portion 27. The seal portion 27 has a first seal layer 24 and a second seal layer 25. The first seal layer 24 faces towards the interior of the transition duct 6. The second seal layer 25 faces towards the exterior of the transition duct 6.

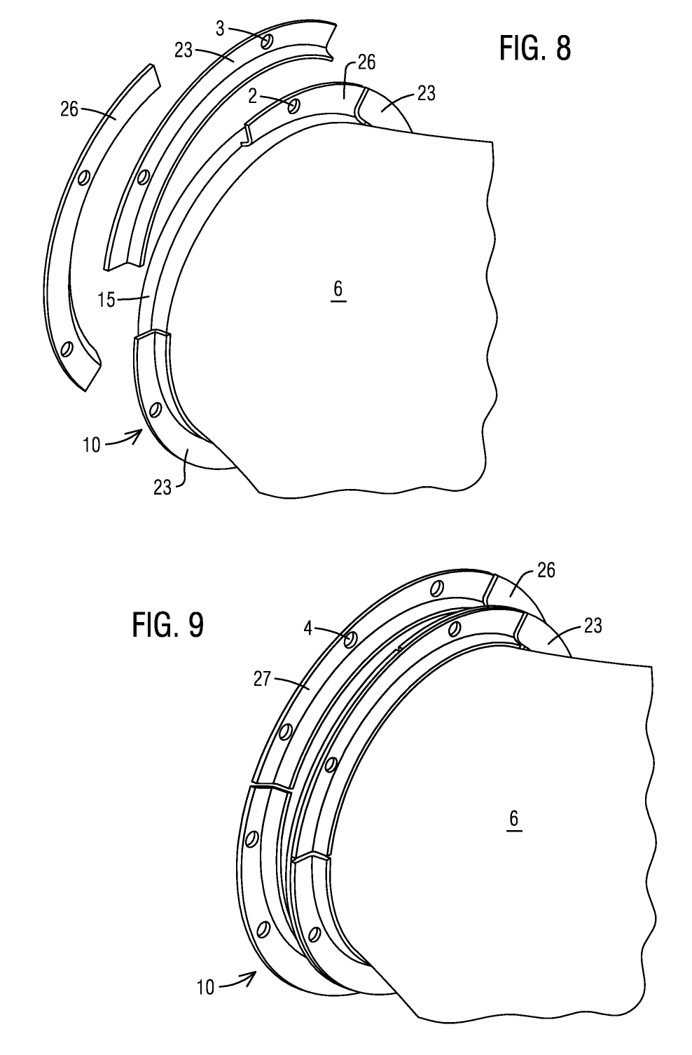

The crown holder 22 has a first holder portion 23 and a second holder portion 26. The first holder portion 23 is located upstream of the second holder portion 26. The first holder portion 23 has a first curved surface 28 that curves and extends in the upstream direction, i.e. towards the combustor basket 12. The second holder portion 26 has a second curved surface 29 that curves and extends in the downstream direction, i.e. towards the IEP 8. While a first holder portion 23 and second holder portion 26 are shown, it should be understood that this can be formed as a single unitary piece. The seal portion 27 and the crown holder 22 have holes 2, 3, and 4 (shown clearly in FIGS. 8 and 9) that receive bolts 18, which are secured by nuts 19. The bolts 18 and nuts 19 secure the seal portion 27 and the crown holder 22 together.

The transition duct 6 has a crown portion 15 that extends circumferentially around the circumference of the transition duct 6. The crown portion 15 may be made of continuous fiber layers in order to avoid any shearing that may occur to the crown portion 15. Alternatively the crown portion 15 may be made of an integrally formed material.

The crown portion 15 may have a curved surface 21 that is formed from the continuous fibrous layers. The curved surface 21 may form an arc that may extends between a chord length of 10.0 mm to 80.0 mm, and more preferably 20.0 mm to 70.0 mm. The curved surface 21 may rise off the transition duct 6 between a distance of between 1.0 mm to 20.0 mm, and more preferably between 5.0 mm and 15.0 mm.

The first holder portion 23 may have a curved surface 28 that engages a portion of the curved surface 21. The second holder portion 26 may have a curved surface 29 that engages a portion of the curved surface 21. In the embodiment shown, each of the curved surfaces 28, 29 forms an arc length of between 10.0 mm to 80.0 mm, and more preferably between 25.0 mm and 70.0 mm. The shapes of curved surfaces 28, 29 preferably correspond to the shape of the curved surface 21.

In the embodiment shown there is a cooling reservoir 43 between the curved surfaces 28, 29 of the first holder portion 23 and the second holder portion 26. The cooling reservoir 43 results from the first holder portion 23 curving in the upstream direction and the second holder portion 26 curving in the downstream direction when installed on the transition duct 6. Air enters through cooling air supply holes 44 formed on the first holder portion 23 into the cooling reservoir 43 and exits through purge holes 45 formed on the second holder portion 26. The cooling reservoir 43 cools the crown portion 15 and supplies purge air into the cavity behind the flange of the IEP 8.

The curved surfaces 28, 29 of the first holder portion 23 and the second holder portion 26 accommodate movements in radial and axial directions of the transition duct 6 that occur during the operation of the gas turbine engine 100.

Seal portion 27 has a first layer 24 and second layer 25. First layer 24 and second layer 25 can be used to be shifted circumferentially to create an offset and form a shiplap between segments. The shiplap can form a seal. The gas path side will be filled with cool purge air and prevents ingestion of combustion gases. The first layer 24 faces internally with respect to the IEP 8 and the transition duct 6. The second layer 25 faces externally with respect to the IEP 8 and the transition duct 6. The seal portion 27 abuts the IEP 8 thereby inhibiting the flow of air through the gap that is formed during the connection of the IEP 8 and the transition duct 6. The seal portion 27 may generally have a U shape when viewed in cross-section. However, it should be understood that other shapes are contemplated, such as J shaped, L-shaped (discussed below), C shaped, etc. The shape of the seal portion 27 should be such that it is able to inhibit the flow of air that occurs in the gas turbine engine 100 through the gap formed between the IEP 8 and the transition duct 6.

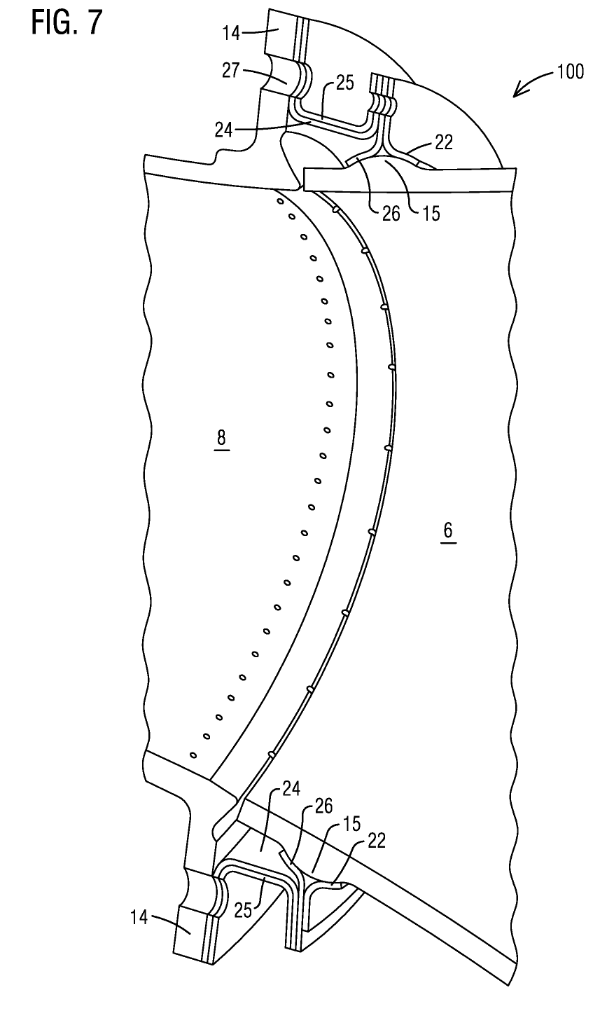

Referring now to FIGS. 8-9, the transition duct supporter 10 extends around the entire circumference of the transition duct 6. It should be understood that the various components of the transition duct supporter 10 may be continuous or segmented. When the components of the transition duct supporter 10 are segmented the individual components are able to be more flexible than when maintained as an integrated whole. Furthermore, first holder portion 23 and second holder portion 26 are preferably segmented for installation. FIGS. 8 and 9 show the various components of the transition duct supporter 10 being installed around the surface of the transition duct 6. From these figures it can be seen that the various segments of the transition duct support 10 may be ship lapped so as to provide more structural integrity when fully assembled. In the embodiment shown in FIGS. 8 and 9, each of the first support portions 23 and the second support portions 26 may form an arc of 120°, however it should be understood that other configurations may be formed using more or less first support portions 23 and second support portions 26 so that the arc length may be different. The same holds true for seal portion 27 assembled around the transition duct 26, which forms an arc of 120° as shown in FIG. 7, but may form other arc lengths.

As shown in FIG. 8, the seal portion 27 may be arranged so that the edges where each seal portion 27 meets another seal portion 27 do not align with where each first support portion 23 meets another first support portion 23 and each second support portion 26 meets another second support portion 26.

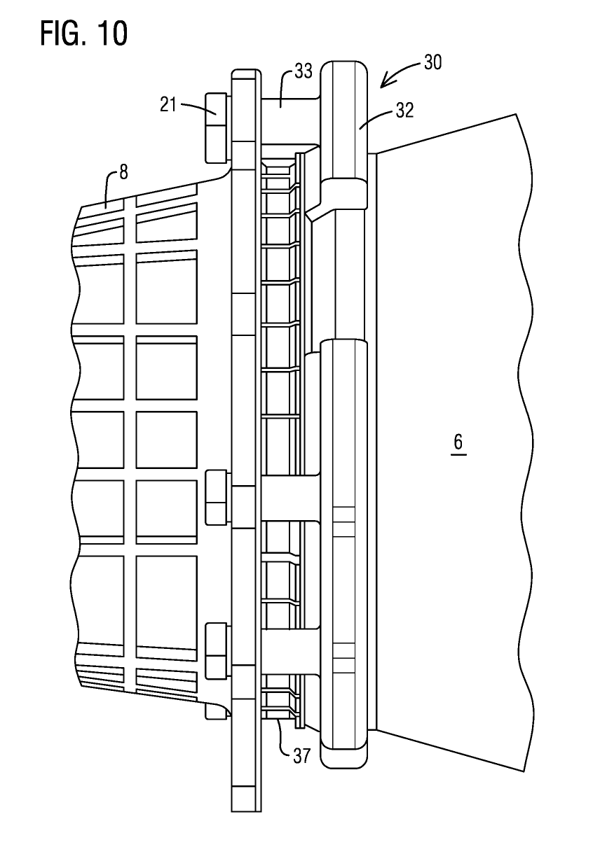

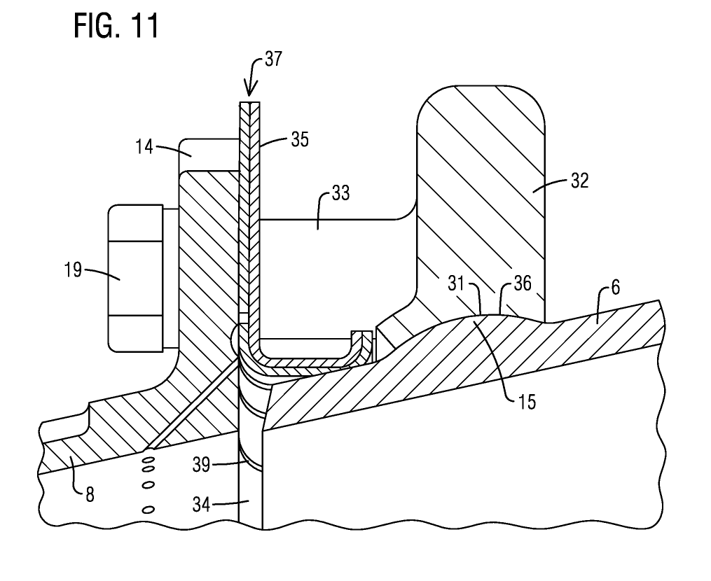

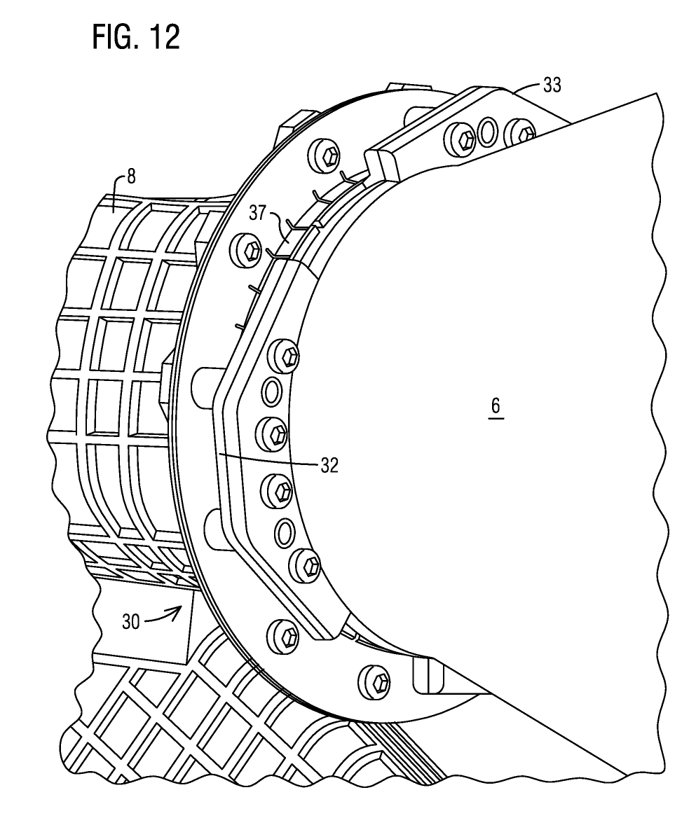

FIGS. 10-12 show an alternative embodiment that uses transition duct supporter 30. The transition duct supporter 30 has a crown lock 32, spacer 33 and seal portion 37 having a first layer 34 and second layer 35.

As discussed above, the transition duct 6 has a crown portion 15 that extends circumferentially around the circumference of the transition duct 6. The crown portion 15 may be made of a continuous fiber layers in order to avoid any shearing that may occur to the duct crown 15. Alternatively the crown portion 15 may be an integrated single piece. The crown portion 15 has a curved surface 31. The curved surface 31 may form an arc that extends between a chord length of between 10.0 mm-80.0 mm, and more preferably between 25.0 mm and 70.0 mm. The arc surface may rise off the transition duct between a distance of between 1.0 mm-20.0 mm and more preferably between 5.0 mm to 15.0 mm.

Crown lock 32 is formed from a unitary piece that has a curved surface 36 that corresponds to the curved surface 31 of the crown portion 15. In the embodiment shown, the curved surface 36 has an arc length of between 20.0 mm to 80.0 mm, and more preferably between 25.0 mm and 70.0 mm. The curved surface 36 of the crown lock 32 and the curved surface 31 of the crown portion 15 accommodates movements in a radial and axial direction of the transition duct 6 that occurs during the operation of the gas turbine engine 100. The crown lock 32 may be one of a plurality of crown locks 32. The plurality of the crown locks 32 may be spaced circumferentially around the transition duct 6. Alternatively the crown lock 32 may be an integrated piece. Having the crown lock 32 be segmented permits additional flexibility of the transition duct supporter 30 during operation of the gas turbine engine 100. The segmentation also facilitates installation of the crown lock 32.

Seal portion 37 has a first layer 34 and second layer 35. First layer 34 and second layer 35 are used to reduce rigidity and can be used to form a shiplap. The first layer 34 faces internally. The second layer 35 faces externally. The first layer 34 may have flex slots 39. The flex slots 39 are located on the first layer 34 where the seal portion 37 inhibits the flow of air. The flex slots 39 are able to accommodate deformations that may occur during the operation of the gas turbine engine 100. Accommodation of the deformations can assist in maintaining the structural integrity of the transition duct supporter 30 as well as the IEP 8 and the transition duct 6.

The seal portion 37 abuts the IEP 8 thereby inhibiting the flow of air through the gap that is formed during the connection of the IEP 8 and the transition duct 6. The seal portion 37 may generally have an L shape when viewed in cross section. At the distal end of the seal portion 37, located proximate to the curved surface 36, there is a lip formed so as to prevent damage to the crown portion 15 and the crown lock 32 during operation of the gas turbine engine 100. However, it should be understood that other shapes are contemplated, such as J shaped, C shaped, etc. The shape of the seal portion 37 should be such that it is able to inhibit the flow of air that occurs in the gas turbine engine 100.

The transition duct supporter 30 extends around the entire circumference of the transition duct 6. It should be understood that the various components of the transition duct supporter 30 may be continuous or segmented. When the components of the transition duct supporter 30 are segmented the individual components are able to be more flexible than when maintained as an integrated whole.

Also forming part of the transition duct supporter 30 is spacer 33. Spacer 33 accommodates bolt 19 and secures the transition duct supporter 30 to the crown lock 32.

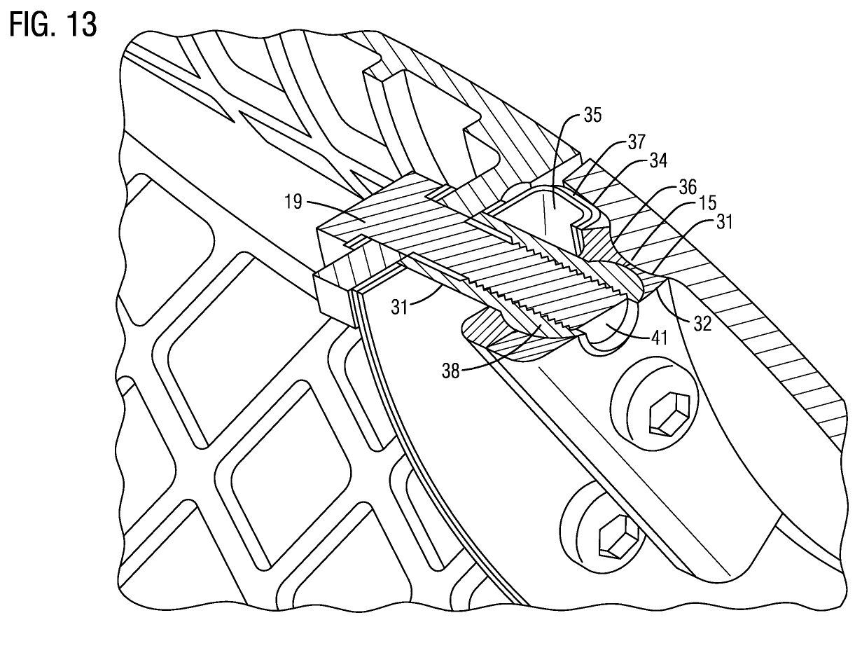

FIG. 13 shows an embodiment where there is a ball joint 38 that forms part of the spacer 33. The ball joint 38 forms part of the transition duct supporter 30 in order to provide additional flexibility. The ball joint 33 is spherically shaped and moves within a cavity 41 formed within the crown lock 32. The cavity 41 is shaped and sized to accommodate movement of the ball joint 33.

Crown lock 32 is formed from a unitary piece that has a curved surface 36 that corresponds to the curved surface 31 of the crown portion 15. In the embodiment shown, the curved surface 36 and 31 has an arc length of between 10.0 mm to 80.0 mm, and more preferably between 25.0 mm and 70.0 mm. The curved surface 36 of the crown lock 32 and the curved surface 31 of the crown portion 15 accommodates movements in the radial and axial direction of the transition duct 6 that occurs during the operation of the gas turbine engine 100. The crown lock 32 may be one of a plurality of crown locks 32 spaced circumferentially around the transition duct 6. Alternatively the crown lock 32 may be an integrated piece. Having the crown lock 32 be segmented permits additional flexibility of the transition duct supporter 30 during operation of the gas turbine engine 100.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A gas turbine engine comprising:
a combustor basket;
a transition duct connected to the combustor basket, wherein the transition duct has a crown portion forming a first curved surface;
an inlet extension piece connected to the transition duct with a transition duct supporter, wherein the transition duct supporter comprises;
a crown holder, wherein the crown holder has a first holder portion having a second curved surface and a second holder portion having a third curved surface, wherein the second curved surface and third curved surface interfaces with the first curved surface; and
a seal portion secured to the crown holder, wherein the seal portion abuts the inlet extension piece thereby inhibiting the flow of air.

2. The gas turbine engine of claim 1, wherein the seal portion has a first layer and a second layer, wherein the first layer is adjacent to the inlet extension piece.

3. The gas turbine engine of claim 1, wherein the crown portion is formed from continuous fiber layers.

4. The gas turbine engine of claim 1, wherein the transition duct is made of ceramic matrix composites.

5. The gas turbine engine of claim 4, wherein the inlet extension piece is made of metal.

6. The gas turbine engine of claim 1, wherein the crown holder is one of a plurality of crown holders.

7. The gas turbine engine of claim 1, wherein the seal portion has a plurality of flexible slots.

8. The gas turbine engine of claim 1, wherein the seal portion is one of a plurality of seal portions.

9. The gas turbine engine of claim 1, wherein the seal portion is generally U shaped when viewed in cross section.

10. A gas turbine engine comprising:
a combustor basket;
a transition duct connected to the combustor basket, wherein the transition duct has a crown portion forming a first curved surface;
an inlet extension piece connected to the transition duct with a transition duct supporter, wherein the transition duct supporter comprises;
a crown lock, wherein the crown lock has a second curved surface that interfaces with the first curved surface;
a seal portion abutting the inlet extension piece thereby inhibiting the flow of air; and
a spacer separating the crown lock from the seal portion, wherein the seal portion and the crown lock are secured together through the spacer.

11. The gas turbine engine of claim 10, wherein the seal portion has a first layer and a second layer, wherein the first layer is adjacent to the inlet extension piece.

12. The gas turbine engine of claim 10, wherein the crown portion is formed from continuous fiber layers.

13. The gas turbine engine of claim 10, wherein the transition duct is made of ceramic matrix composites.

14. The gas turbine engine of claim 13, wherein the inlet extension piece is made of metal.

15. The gas turbine engine of claim 10, wherein the crown lock is one of a plurality of crown locks.

16. The gas turbine engine of claim 10, wherein the seal portion has a plurality of flexible slots.

17. The gas turbine engine of claim 10, wherein the spacer further comprises a ball joint.

18. The gas turbine engine of claim 10, wherein the seal portion is generally L shaped when viewed in cross section.

19. A transition duct supporter for use in gas turbine engines comprising:
a crown holder, wherein the crown holder has a first holder portion having a first curved surface and a second holder portion having a second curved surface, wherein the first curved surface and second curved surface interfaces with a third curved surface of a crown portion formed on a transition duct; and
a seal portion secured to the crown holder, wherein the seal portion abuts an inlet extension piece thereby inhibiting the flow of air.

20. The transition duct support of claim 19, wherein the seal portion has a plurality of flexible slots.
